(19) United States
(12) Patent Application Publication
(10) Pub. No.: US 2024/0119350 A1
(43) Pub. Date: Apr. 11, 2024

(54) RUNTIME RECOMMENDATIONS FOR ARTIFICIAL INTELLIGENCE MODEL TRAINING

(71) Applicant: International Business Machines Corporation, Armonk, NY (US)

(72) Inventors: He Sheng Yang, Beijing (CN); Mo Chi Liu, Beijing (CN); Yun Wang, Beijing (CN); Hong Wei Jia, Beijing (CN); Wu Yan, San Jose, CA (US); Xiaoyang Yang, San Francisco, CA (US)

(21) Appl. No.: 18/045,669

(22) Filed: Oct. 11, 2022

(51) Int. Cl. G06N 20/00

(52) U.S. Cl. CPC G06N 20/00

(57) ABSTRACT

According to an aspect, a computer-implemented method includes accessing a profile of a user that indicates a likelihood that the user will execute each of a plurality of types of processing when training a new AI model. A runtime matrix that includes identifiers of runtime environments is accessed. The matrix also includes, for each of the runtime environments, a frequency of use of the runtime environment to train previously trained AI models using each of the plurality of types of processing. One or more of the runtime environments is selected for output to the user based at least in part on the profile of the user and the runtime matrix. Identifiers of the selected one or more of the runtime environments are output to a user interface of the user along with a suggestion to use one of the selected one or more of the runtime environments.

### BACKGROUND

The present invention generally relates to computer runtime environments, and more specifically, to computer systems, computer-implemented methods, and computer program products for providing runtime environment recommendations for artificial intelligence (AI) model training based on users' past programming behaviors.

AI modeling is the creation, training, and deployment of machine learning algorithms that emulate logical decision-making based on available data. AI models provide a foundation to support advanced intelligence methodologies such as real-time analytics, predictive analytics, and augmented analytics. These models use various types of algorithms, such as linear or logistic regression, to recognize patterns in the data and to draw conclusions in a manner that emulates human expertise. Training an AI model can involve processing large amounts of data through the AI model in iterative test loops executing in a runtime environment and checking the results to ensure accuracy, and to ensure that the model is behaving as expected and desired. The AI model is modified and improved based on the training. Once the model is trained it can be deployed for use which can include inferring conclusions based on available data.

### SUMMARY

Embodiments of the present invention are directed to a computer-implemented method for providing runtime recommendations for artificial intelligence (AI) model training based on users' programing behaviors. The method includes accessing a profile of a user. The profile indicates a likelihood that the user will execute each of a plurality of types of processing when training a new AI model. A runtime matrix that includes identifiers of runtime environments is accessed. The matrix also includes, for each of the runtime environments, a frequency of use of the runtime environment to train previously trained AI models using each of the plurality of types of processing. One or more of the runtime environments is selected for output to the user. The selecting is based at least in part on the profile of the user and the runtime matrix. Identifiers of the selected one or more of the runtime environments are output to a user interface of the user along with a suggestion to use one of the selected one or more of the runtime environments to train the new AI model.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 depicts a block diagram of an environment for providing runtime recommendations for artificial intelligence (AI) model training in accordance with one or more embodiments of the present invention;

FIG. 3 depicts an example of a runtime dataset in accordance with one or more embodiments of the present invention;

FIG. 4 depicts a block diagram of processing performed by the user profiling component in accordance with one or more embodiments of the present invention;

FIG. 5 depicts processing performed by the runtime recommender component in accordance with one or more embodiments of the present invention; and

FIG. 6 depicts a flowchart of a method for providing runtime recommendations for AI model training in accordance with one or more embodiments of the present invention.

### DETAILED DESCRIPTION

Embodiments of the present invention are directed to runtime environment recommendations for artificial intelligence (AI) model training. In one or more embodiments of the present invention, the runtime environment recommendations provided to a user are based on the user's programming behaviors. As used herein, the term “runtime” or “runtime environment” refers to a combination of computing resources that are used execute the AI model training. Examples of computing resources that can be part of a runtime environment configuration include hardware resources such as but not limited to central processing unit (CPU) cores, memory, and graphical processing units (GPUs), and software libraries such as but not limited to Python®, Scikit Learn®, and XGBoost. As used herein, the term “AI model” refers to a mathematical model that is trained using data and/or human expert input to replicate a decision an expert would make when provided with the same information.

One environment where embodiments of the invention described herein can be utilized is with IBM Cloud Pak® for Data which is a fully integrated enterprise data and AI platform that modernizes how businesses collect, organize and analyze data to infuse AI throughout their organizations. Users such as data engineers and data scientists can develop data models with the latest advanced AI technologies with the AI modeling tools in IBM Cloud Pak for Data. In order to train a model using IBM Cloud Pak for Data, a data scientist has to select an appropriate runtime environment. IBM Cloud Pak for Data provides predefined runtimes with configurations which may not match a project requirement exactly, and thus IBM Cloud Pak for Data allows users to define custom runtime environment definitions.

Knowing about customized runtime definitions can be useful for other users, particularly those who do not have much experience in building runtime configurations and/or those who have similar training processes or requirements. One or more embodiments of the present invention facilitate the sharing of customized runtime environments by recommending appropriate runtime environments to users based on a user's precious programing behaviors. This can lead to expediting the building of AI models and to an improved user experience.

IBM Cloud Pak for Data is used in examples described herein as an example of one platform that can use one or more embodiments of the present invention to provide runtime recommendations for AI model training. Embodiments are not restricted to use with IBM Cloud Pak for Data and embodiments can be used with other platforms that train AI models such as, but not limited to IBM SPSS® Modeler and Jupyter Notebook

One or more embodiments described herein provide an AI model training runtime cache system to persist (or save) user defined runtimes and to recommend a runtime(s) from the cache based on a user's programming behaviors and/or the user's data analytics profile. This can be performed by introducing recommendation algorithms to runtime cache management so that the user can dynamically select a runtime environment from the recommended runtime environment list.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as the runtime recommendations for AI model training block 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

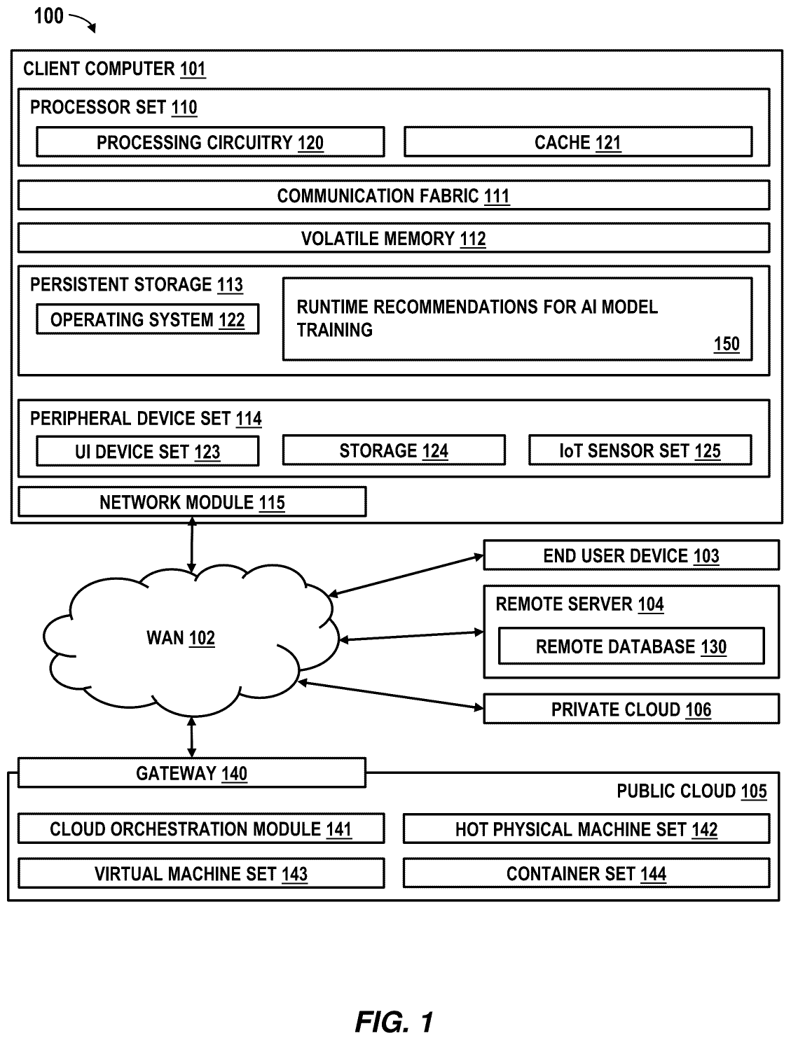

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In exemplary embodiments, methods, systems, and computer program products for virtual machine failover using disaggregated shared memory are provided. In one embodiment, a virtual machine disposed on a first computing system is configured to store the main program memory in a shared memory device that is separate from the first computing system. When a failure of the first computing device is detected, the virtual machine is restored on a second computing system using the main program memory from the shared memory device.

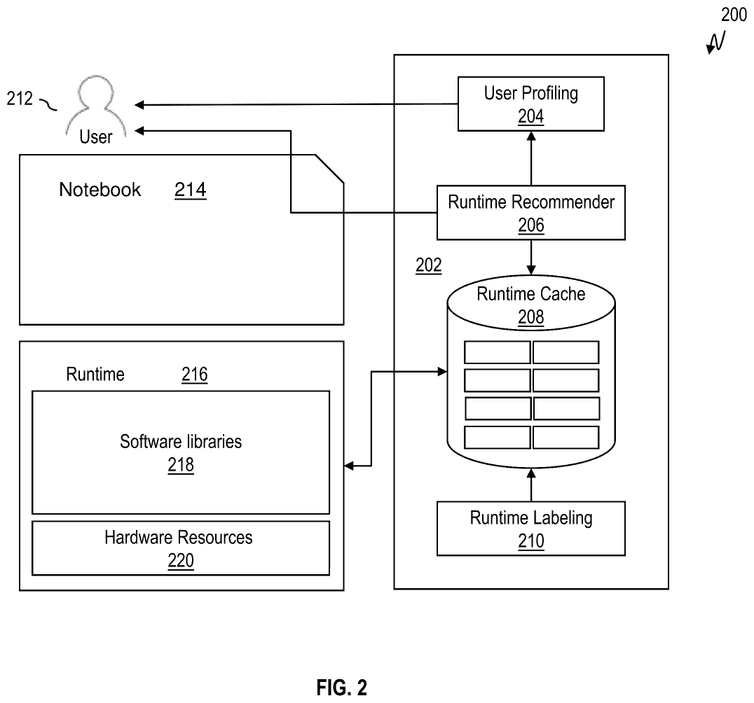

Turning now to FIG. 2, a block diagram of an environment 200 for providing runtime recommendations for AI model training is generally shown in accordance with one or more embodiments of the present invention. As illustrated in FIG. 2, the environment 200 includes a user 212, a runtime cache manager 202, a notebook 214, and a runtime 216. In exemplary embodiments, all or a portion of one or more of the runtime cache manager 202, the notebook 214 and the runtime 216 are embodied in computer 101 of FIG. 1.

The runtime cache manager 202 shown in FIG. 2 includes a user profiling component 204, a runtime recommender component 206, runtime cache repository 208, and a runtime labeling component 210. In accordance with one or more embodiments of the present invention, the runtime cache repository 208 persists, or stores, all user defined runtime configurations and a machine learning algorithm is used to classify each entry in the runtime cache repository 208 to build a profile of the runtime configurations. Runtime labeling component 210 uses a machine learning clustering algorithm, such as but not limited to K Nearest Neighbors (KNN), to categorize the runtime into groups, or types. The groups can include, but are not limited to binary classification on a small dataset, regression on a large dataset, multiple classification on a large dataset, computer vision (CV), time service forecasting, and natural language processing (NLP). User profiling component 204 builds a weighted runtime matrix based on a user's programing behavior history. This can be used to determine the past runtime preferences of the user when tackling different types of data analytics problems.

The runtime recommender component 206 shown in FIG. 2 uses a recommendation algorithm to recommend runtimes for a user. It combines the user's profile created by user profiling component 204 and the runtime classification generated by runtime labeling component 210 to recommend one or more particular runtime environments from the runtime cache repository 208. The recommendation can save the user 212 from having to search for or to define a runtime configuration for training a data model for use in a platform such as but not limited to IBM Cloud Pak for Data. This allows users to share best practices in defining runtime configurations for training data models.

In accordance with one or more embodiments of the present invention, the example training runtime 216 shown in FIG. 2 is stored in runtime cache repository 208 and it specifies runtime configuration information including one or more software libraries 218 and one or more hardware resources 220 that are used during execution of the training runtime 216. Examples of software libraries 218 that can be used include, but are not limited to Python, Scikit Learn, and XGBoost. Examples of hardware resources 220 that can be used include, but are not limited to processors and memory. The runtime cache manager 202 of FIG. 2 also includes the notebook 214 which is used to record information about the training of the AI model such as, but not limited to an identifier of the runtime configuration, a location and/or format of the training data, and the location of the AI model. The notebook 214 is run, or executed, on a processor to train an AI data model.

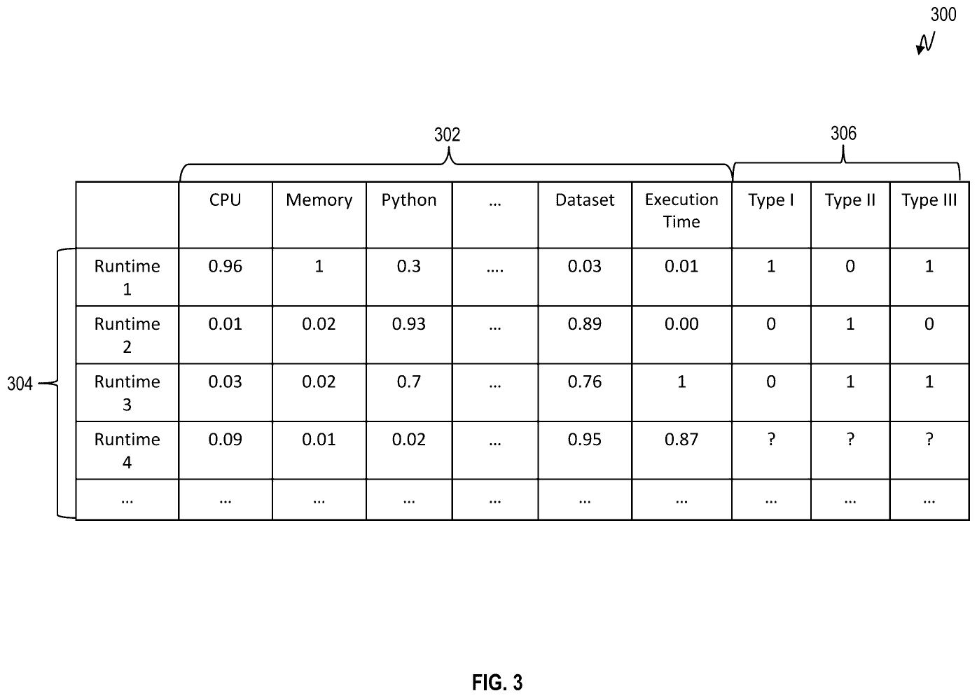

Turning now to FIG. 3, an example of a runtime dataset 300 that is generated by runtime labeling component 210 of FIG. 2 is generally shown in accordance with one or more embodiments of the present invention. The runtime dataset 300 shown in FIG. 3 includes features 302 collected for each of a plurality of runtimes 304. In accordance with one or more embodiments of the present invention, the features 302 include software libraries 218 and hardware resources 220 of the runtime 216. The features 302 shown in the runtime dataset 300 of FIG. 3 include CPU usage, memory usage, Python usage, dataset size, and execution time. The runtimes 304 shown in FIG. 3 are labeled Runtime 1, Runtime 2, Runtime 3, and Runtime 4. Runtime 1 has a CPU usage of 0.96, a memory usage of 1, a Python usage of 0.3, a dataset size of 0.03, and an execution time of 0.01.

In order to train an AI data model, using IBM Cloud Pak for Data for example, a user (e.g., a data scientist) has to define or select a runtime environment that can execute the notebook, such as notebook 214 of FIG. 2. The selected runtime has to be powerful enough to execute the computation work and be loaded with required software libraries, for example Python libraries such as pandas for operating data frames and NumPy for mathematical operations.

The runtime dataset 300 shown in FIG. 3 can be created by runtime labeling component 210 of FIG. 2. The runtime dataset 300 includes the features 302 that have been collected for all or a proper subset of the runtimes 304 that have been defined and/or executed by one or more users to train an AI model. If the runtime dataset 300 includes a subset of the runtimes, the subset can be selected based on a number of factors such as, but not limited to a project that the user is working on, a department of the user, and/or a time frame. Once all of the features have been collected and stored in the runtime dataset 300 for each of the runtimes, the runtime labeling component 210 can use a machine learning clustering algorithm, such as but not limited to K Nearest Neighbors (KNN), to categorize the runtimes into groups 306.

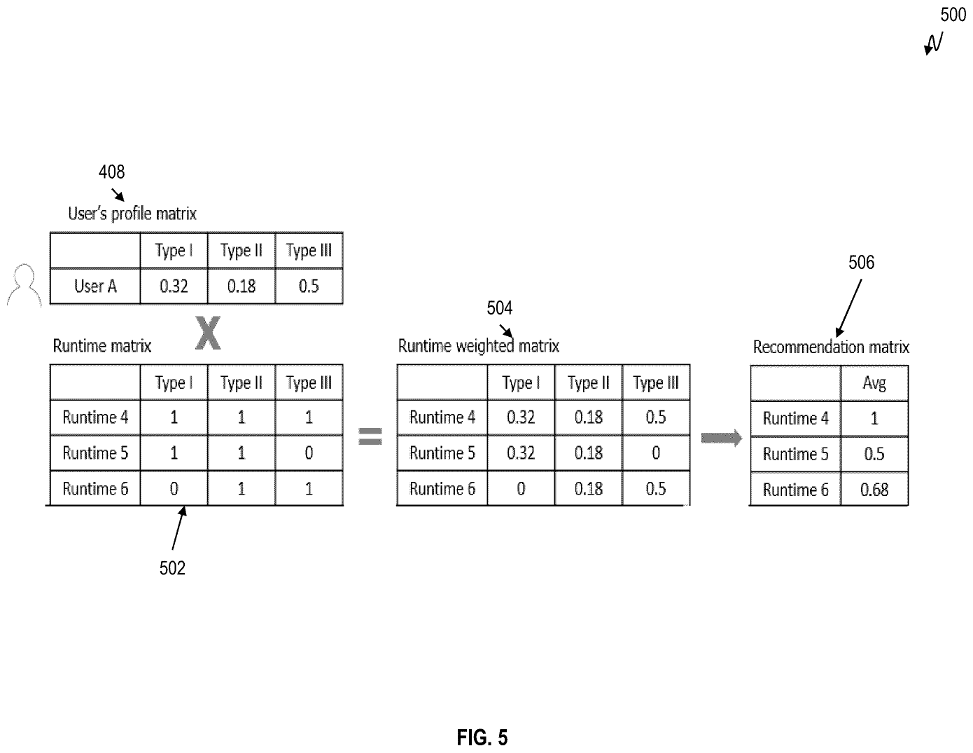

The groups 306 in the runtime dataset 300 shown in FIG. 3 are labeled Type I, Type II, and Type III. As shown in FIG. 3, each runtime 304 can correspond to, or be favorable for, one or more types of processing. For example, Runtime 1 can be recommended for use in Type I and Type III processing, Runtime 2 for Type II processing, and Runtime 3 for Type II and Type III processing. Each group 306 can correspond to a label, or a type, such as, but not limited to, binary classification on small dataset, regression on large dataset, and natural language processing (NLP). The result of the groupings can be stored in a matrix such as runtime matrix 502 of FIG. 5. Once the KNN model is trained from sample runtimes (Runtimes 1, 2, 3 in the example shown in FIG. 3), the suitability of other runtimes (Runtime 4 in the example in FIG. 3) for each of the groups 306, or types, of processing (Type I, Type II, and Type III in the example of FIG. 3) can be predicted.

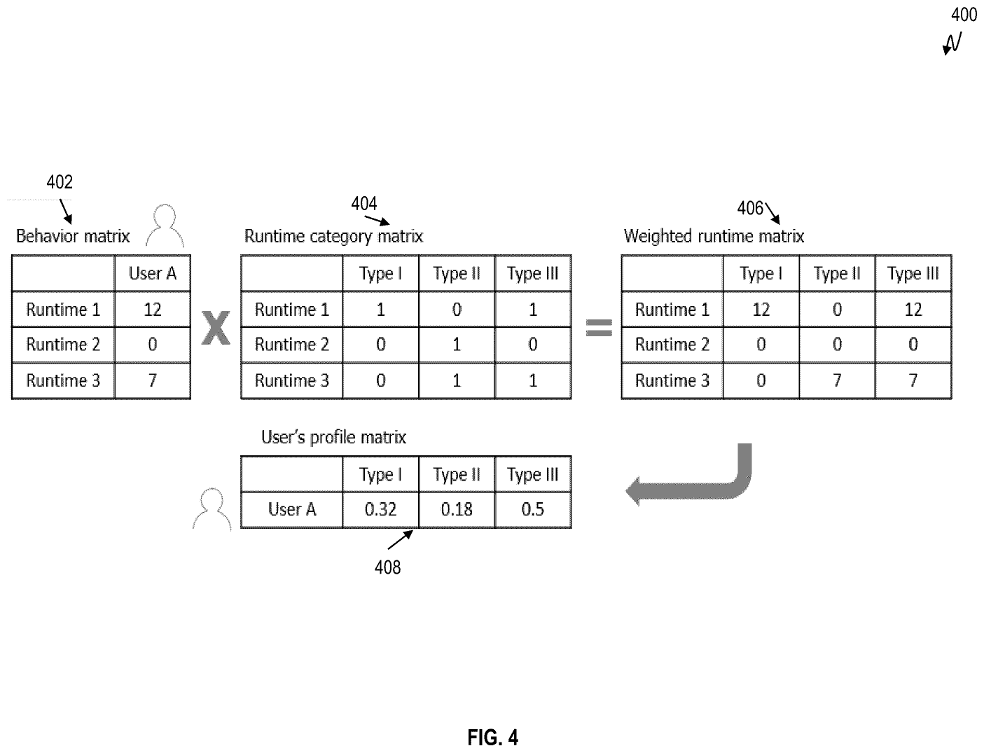

Turning now to FIG. 4, a block diagram 400 of processing performed by the user profiling component 204 of FIG. 2 is generally shown in accordance with one or more embodiments of the present invention. The runtime profiling, as shown in FIG. 4, determines runtime environment preferences of the user for different types of data analytics problems. In accordance with one or more embodiments of the present invention, the types of data analytics problems correspond to the labels, or types, assigned to each of the runtimes by the runtime labeling component 210. The processing shown in FIG. 4 includes tracking the user's programming behavior and recording it in behavior matrix 402. The behavior matrix 402 records what runtime environments the user has selected in the past to train AI models. As shown in behavior matrix 402, the user has used Runtime 1 twelve times, Runtime 3 seven times, and the user has not used Runtime 2.

As shown in FIG. 4, the behavior matrix 402 is multiplied by the runtime category matrix 404 to generate the user's weighted runtime matrix 406. The runtime category matrix 404 shown in FIG. 4 includes a number of times that each runtime has been used by the other users for the different types of processing. As shown in runtime category matrix 404 of FIG. 4, Runtime 1 has been used for Type I processing once and for Type II processing once; Runtime 2 has been used for Type II processing once; and Runtime 3 has been sued for Type II processing once and for Type II processing once.

The weighted runtime matrix 406 for the user is condensed into user's profile matrix 408. As shown in the user's profile matrix 408 in FIG. 4, the user is predicted to perform Type 1 processing thirty-two percent of the time, Type II processing eighteen percent of the time, and Type III processing fifty percent of the time.

Turning now to FIG. 5, a block diagram 500 of processing performed by the runtime recommender component 206 of FIG. 2 is generally shown in accordance with one or more embodiments of the present invention. The runtime recommender component 206 generates a list of recommended runtime environments for presentation to the user. As shown in FIG. 5, the runtime recommender component 206 combines (e.g., multiplies) the user's profile matrix 408 (which includes the likelihood of the user performing different types of processing) with the runtime matrix 502 (which includes the types of processing each runtime has been used for by other users) to generate runtime weighted matrix 504. The runtime weighted matrix 504 shown in FIG. 5 applies to the user associated with the user's profile matrix 408 and it is used to generate the recommendation matrix 506. Contents of the recommendation matrix 506 for the user can be presented to the user (e.g., via a user interface) in priority order based on contents of the runtime weighted matrix 504. In accordance with one or more embodiments of the present invention, the priority is based on the average column in the recommendation matrix 506

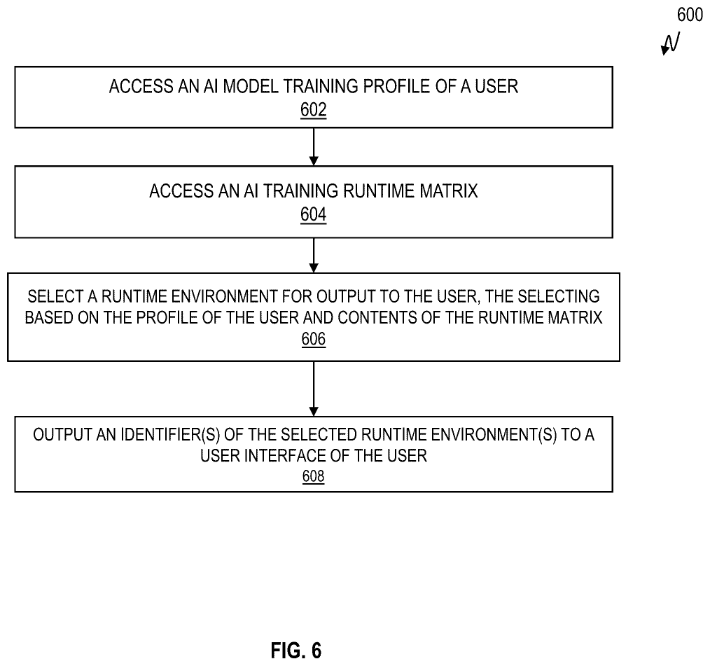

Turning now to FIG. 6, a flowchart of a method 600 for providing runtime recommendations for AI model training is generally shown in accordance with one or more embodiments of the present invention. In one or more embodiments the processing shown in FIG. 6 is performed by computer 101 of FIG. 1. The flowchart shown in FIG. 6 may include additional steps not depicted in FIG. 6. Although depicted in a particular order, the blocks depicted in FIG. 6 can be rearranged, subdivided, and/or combined.

As shown at block 602 of FIG. 6, the method 600 includes accessing a profile of a user, such as user's profile matrix 408 of FIG. 4. The profile of the user indicates a likelihood that the user will execute each of a plurality of types of processing when training a new AI model. The types of processing can include, but are not limited to binary classification on a small dataset, regression on a large dataset, and natural language processing (NLP). In accordance with one or more embodiments of the present invention, method 600 also includes generating the profile of the user based at least on part on one for more runtime environments of the plurality of runtime environments previously used by the user to train one or more other new AI models (e.g., as shown in behavior matrix 402 of FIG. 4) and a type of processing of the plurality of types of processing executed by other users when training the AI models in the runtime environment, as shown in runtime category matrix 404 of FIG. 4. The generating can be further based on one or more types of the plurality of types of processing previously performed by the user when training one or more AI models. An example embodiment of generating the profile of the user is shown in the block diagram 400 of FIG. 4.

At block 604 of FIG. 6, a runtime matrix, such as runtime matrix 502 of FIG. 5, is accessed. The runtime matrix includes identifiers of runtime environments and also includes, for each of the runtime environments, a frequency of past use (by the user and/or other uses) of the runtime environment for each of the plurality of types of processing when training AI models. In accordance with one or more embodiments of the present invention, the method 600 further includes generating the runtime matrix by collecting and storing features of executions of each of the plurality of runtime environments previously used when training the AI models (e.g., as shown in runtime dataset 300 of FIG. 3). The features can include, but are not limited to CPU usage, memory usage, software usage, dataset size, and/or execution time. In accordance with one or more embodiments of the present invention, the generating also includes applying a machine learning clustering algorithm to the plurality of runtime environments in the runtime matrix to categorize each of the plurality of runtime environments into one or more of the plurality of types of processing.

At block 606 of FIG. 6, one or more of the runtime environments are selected for output to the user. The selecting can be based at least in part on the profile of the user and the runtime matrix. An example of generating a recommendation matrix which includes the runtime environments selected for output to the user is shown in the block diagram of FIG. 5. At block 608, identifiers of the selected one or more of the runtime environments are output to a user interface of the user. The outputting includes a suggestion to use one of the selected one or more of the runtime environments to train the new AI model.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
accessing a profile of a user, the profile indicating a likelihood that the user will execute each of a plurality of types of processing when training a new AI model;
accessing a runtime matrix, the runtime matrix comprising identifiers of runtime environments and for each of the runtime environments a frequency of use of the runtime environment to train previously trained AI models using each of the plurality of types of processing;
selecting one or more of the runtime environments for output to the user, the selecting based at least in part on the profile of the user and the runtime matrix; and
outputting identifiers of the selected one or more of the runtime environments to a user interface of the user, the outputting further including a suggestion to use one of the selected one or more of the runtime environments to train the new AI model.

2. The computer-implemented method of claim 1, further comprising generating the profile of the user, the generating based at least in part on one or more runtime environments of the plurality of runtime environments previously used by the user to train one or more other new AI models and on a type of processing of the plurality of types of processing executed by other users when training the previously trained AI models.

3. The computer-implemented method of claim 2, wherein the generating is further based at least in part on one or more types of the plurality of types of processing previously used by the user when training the one or more other new AI models.

4. The computer-implemented method of claim 1, further comprising generating the runtime matrix, the generating comprising collecting and storing features of executions of each of the plurality of runtime environments previously used when training the previously trained AI models.

5. The computer-implemented method of claim 4, wherein the features comprise central processing unit (CPU) usage, memory usage, and execution time.

6. The computer-implemented method of claim 4, wherein the generating further comprises applying a machine learning clustering algorithm to the plurality of runtime environments in the runtime matrix to categorize each of the plurality of runtime environments into one or more of the plurality of types of processing.

7. The computer-implemented method of claim 1, wherein each of the plurality of runtime environments comprises hardware and software.

8. The computer-implemented method of claim 1, wherein the types of processing comprise binary classification on a small dataset, regression on a large dataset, and natural language processing (NLP).

9. A system comprising:
a memory having computer readable instructions; and
one or more processors for executing the computer readable instructions, the computer readable instructions controlling the one or more processors to perform operations comprising:
accessing a profile of a user, the profile indicating a likelihood that the user will execute each of a plurality of types of processing when training a new AI model;
accessing a runtime matrix, the runtime matrix comprising identifiers of runtime environments and for each of the runtime environments a frequency of use of the runtime environment to train previously trained AI models using each of the plurality of types of processing;
selecting one or more of the runtime environments for output to the user, the selecting based at least in part on the profile of the user and the runtime matrix; and
outputting identifiers of the selected one or more of the runtime environments to a user interface of the user, the outputting further including a suggestion to use one of the selected one or more of the runtime environments to train the new AI model.

10. The system of claim 9, wherein the operations further comprise generating the profile of the user, the generating based at least in part on one or more runtime environments of the plurality of runtime environments previously used by the user to train one or more other new AI models and on a type of processing of the plurality of types of processing executed by other users when training the previously trained AI models.

11. The system of claim 10, wherein the generating is further based at least in part on one or more types of the plurality of types of processing previously used by the user when training the one or more other new AI models.

12. The system of claim 9, wherein the operations further comprise generating the runtime matrix, the generating comprising collecting and storing features of executions of each of the plurality of runtime environments previously used when training the previously trained AI models.

13. The system of claim 12, wherein the features comprise central processing unit (CPU) usage, memory usage, and execution time.

14. The system of claim 12, wherein the generating further comprises applying a machine learning clustering algorithm to the plurality of runtime environments in the runtime matrix to categorize each of the plurality of runtime environments into one or more of the plurality of types of processing.

15. The system of claim 9, wherein each of the plurality of runtime environments comprises hardware and software.

16. The system of claim 9, wherein the types of processing comprise binary classification on a small dataset, regression on a large dataset, and natural language processing (NLP).

17. A computer program product comprising a computer readable storage medium having program instructions embodied therewith, the program instructions executable by a processor to cause the processor to perform operations comprising:
accessing a profile of a user, the profile indicating a likelihood that the user will execute each of a plurality of types of processing when training a new AI model;
accessing a runtime matrix, the runtime matrix comprising identifiers of runtime environments and for each of the runtime environments a frequency of use of the runtime environment to train previously trained AI models using each of the plurality of types of processing;
selecting one or more of the runtime environments for output to the user, the selecting based at least in part on the profile of the user and the runtime matrix; and
outputting identifiers of the selected one or more of the runtime environments to a user interface of the user, the outputting further including a suggestion to use one of the selected one or more of the runtime environments to train the new AI model.

18. The computer program product of claim 17, wherein the operations further comprise generating the profile of the user, the generating based at least in part on one or more runtime environments of the plurality of runtime environments previously used by the user to train one or more other new AI models and on a type of processing of the plurality of types of processing executed by other users when training the previously trained AI models.

19. The computer program product of claim 17, wherein the operations further comprise generating the runtime matrix, the generating comprising collecting and storing features of executions of each of the plurality of runtime environments previously used when training the previously trained AI models, and the features comprise central processing unit (CPU) usage, memory usage, and execution time.

20. The computer program product of claim 17, wherein the types of processing comprise binary classification on a small dataset, regression on a large dataset, and natural language processing (NLP).
